(19) United States
(12) Patent Application Publication
(10) Pub. No.: US 2013/0016290 A1
(43) Pub. Date: Jan. 17, 2013

(54) TELEVISION AND ELECTRONIC APPARATUS

(71) Applicant: Issei Takahashi, Ome-shi (JP)

(72) Inventor: Issei Takahashi, Ome-shi (JP)

(73) Assignee: KABUSHIKI KAISHA TOSHIBA, Tokyo (JP)

(21) Appl. No.: 13/453,852

(22) Filed: Apr. 23, 2012

(30) Foreign Application Priority Data
Jul. 14, 2011 (JP) 2011-156003

(51) Int. Cl. H04N 5/64

(52) U.S. Cl. 348/836; 348/E05.128

(57) ABSTRACT

According to one embodiment, an electronic apparatus includes a housing, a circuit board, a fan, a first air guide, and a second air guide. The housing includes an exhaust hole. The circuit board is in the housing and includes a heat-generating component. The fan is in the housing. The first air guide is configured to guide air from the fan toward the exhaust hole through the heat-generating component. The second air guide is in the first air guide.

### CROSS-REFERENCE TO RELATED APPLICATIONS

This application is based upon and claims the benefit of priority from prior Japanese Patent Application No. 2011-156003, filed Jul. 14, 2011, the entire contents of which are incorporated herein by reference.

### FIELD

Embodiments described herein relate generally to a television and an electronic apparatus.

### BACKGROUND

Some electronic apparatuses include a heat-generating component, a fan, and a heat sink.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary front view of a television according to a first embodiment;

FIG. 2 is an exemplary back view of the internal structure of the television illustrated in FIG. 1;

FIG. 3 is an exemplary cross-sectional view schematically illustrating the internal structure of the television illustrated in FIG. 2;

FIG. 4 is an exemplary cross-sectional view of a first modification of a second air guide illustrated in FIG. 2;

FIG. 5 is an exemplary cross-sectional view of a second modification of a second air guide illustrated in FIG. 2;

FIG. 6 is an exemplary cross-sectional view of the second air guide illustrated in FIG. 2;

FIG. 7 is an exemplary perspective view of an electronic apparatus according to a second embodiment;

FIG. 8 is an exemplary perspective view of the internal structure of the electronic apparatus illustrated in FIG. 7;

FIG. 9 is an exemplary perspective view of the inner surface of a cover illustrated in FIG. 8;

FIG. 10 is an exemplary cross-sectional view of the internal structure of the electronic apparatus illustrated in FIG. 8;

FIG. 11 is an exemplary cross-sectional view schematically illustrating the internal structure of an electronic apparatus according to a third embodiment;

FIG. 12 is an exemplary cross-sectional view schematically illustrating the internal structure of a modification of the electronic apparatus according to the third embodiment;

FIG. 13 is an exemplary cross-sectional view of the internal structure of an electronic apparatus according to a fourth embodiment;

FIG. 14 is an exemplary cross-sectional view of the internal structure of an electronic apparatus according to a fifth embodiment;

FIG. 15 is an exemplary perspective view of the internal structure of an electronic apparatus according to a sixth embodiment;

FIG. 16 is an exemplary cross-sectional view of the internal structure of the electronic apparatus according to the sixth embodiment;

FIG. 17 is an exemplary cross-sectional view of a heat pipe according to the sixth embodiment;

FIG. 18 is an exemplary cross-sectional view of a portion of the internal structure of the electronic apparatus according to the sixth embodiment;

FIG. 19 is an exemplary cross-sectional view of the internal structure of an electronic apparatus according to a seventh embodiment; and

FIG. 20 is an exemplary perspective view of the internal structure of an electronic apparatus according to an eighth embodiment.

### DETAILED DESCRIPTION

Various embodiments will be described hereinafter with reference to the accompanying drawings.

In general, according to one embodiment, an electronic apparatus comprises a housing, a circuit board, a fan, a first air guide, and a second air guide. The housing comprises an exhaust hole. The circuit board is in the housing and comprises a heat-generating component. The fan is in the housing. The first air guide is configured to guide air from the fan toward the exhaust hole through the heat-generating component. The second air guide is in the first air guide.

Hereinafter, exemplary embodiments will be described with reference to the accompanying drawings.

### First Embodiment

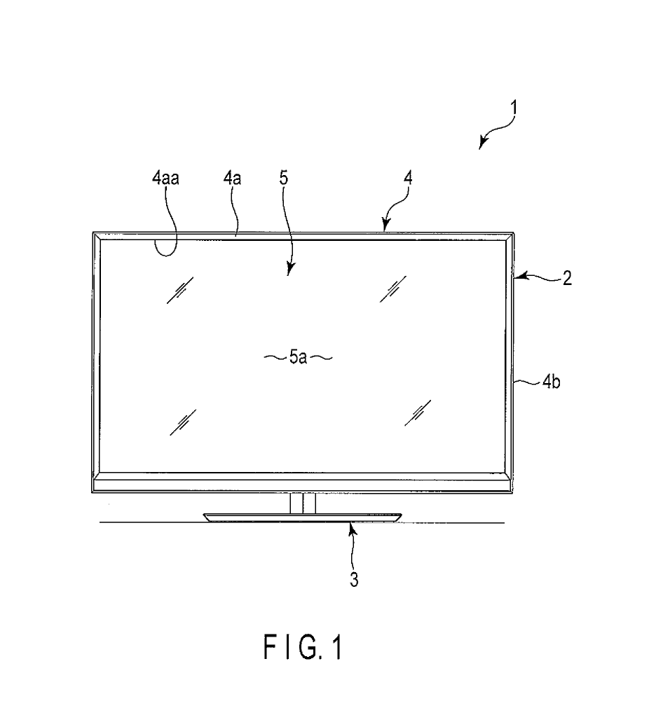

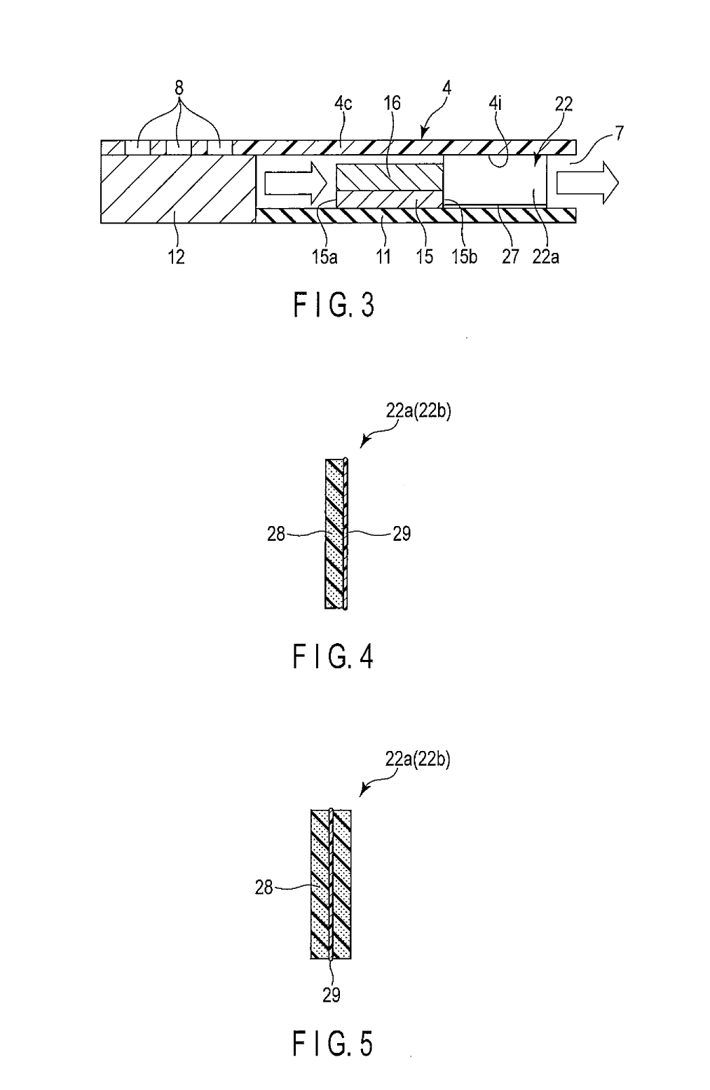

FIGS. 1 to 6 illustrate a television 1 according to a first embodiment. The television 1 is an example of an “electronic apparatus”. As shown in FIG. 1, the television 1 includes a display unit 2 and a stand 3 supporting the display unit 2. The display unit 2 includes a housing 4 and a display device 5 provided in the housing 4. The housing 4 includes a front wall 4a, a rear wall 4c (see FIG. 3), and a circumferential wall 4b extending between the front wall 4a and the rear wall 4c. The display device 5 includes a display screen 5a on which images are displayed. The front wall 4a of the housing 4 includes an opening portion 4aa through which the display screen 5a is exposed.

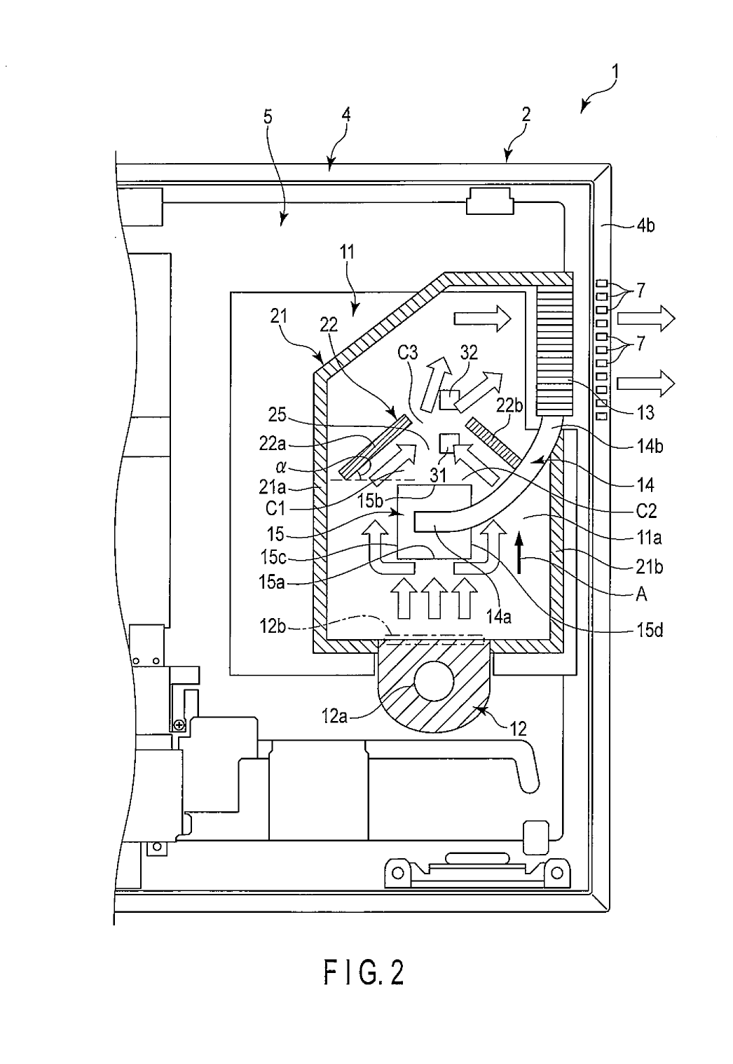

FIG. 2 is a diagram schematically illustrating the internal structure of the housing 4. In FIG. 2, for convenience of explanation, some members are hatched. As shown in FIG. 2, at least one of the circumferential wall 4b (i.e., side wall) and the rear wall 4c of the housing 4 includes a plurality of exhaust holes 7 (i.e., openings). The exhaust holes 7 are formed in, for example, the longitudinal direction of the housing 4 (i.e., the longitudinal direction of the display screen 5a). That is, the exhaust holes 7 are formed in a direction crossing (e.g., a direction substantially perpendicular to) the direction in which a discharge hole 12b of a fan 12, which will be described below, is formed.

The housing 4 includes a circuit board 11, the fan 12, a heat sink 13, and a thermally-conductive member 14. The circuit board 11 is an example of a “board”. The fan 12 is provided away from the circumferential wall 4b of the housing 4 and away from the exhaust holes 7. The fan 12 includes a fan case and fan blades which rotate in the fan case. The fan case includes an air inlet 12a (i.e., first opening) and a discharge hole 12b (i.e., second opening).

The air inlet 12a is formed in the thickness direction of the housing 4 and faces, for example, the rear wall 4c of the housing 4. Intake holes 8 (i.e., openings) are formed in the rear wall 4c of the housing 4 at positions corresponding to the air inlet 12a of the fan 12. The air inlet 12a of the fan 12 faces the intake holes 8 of the housing 4. In this way, the fan 12 can draw air which is not heated (i.e., relatively cold air or outside air) through the intake holes 8 of the housing 4.

The discharge hole 12b is formed in a direction from the fan 12 to a first heat-generating component 15 (which will be described below). That is, the discharge hole 12b is formed in a direction crossing (e.g., a direction substantially perpendicular to) the thickness direction of the housing 4, that is, the lateral direction of the housing 4 (i.e., the lateral direction of the display screen 5a). The fan 12 is a so-called centrifugal type. The fan 12 draws air which is not heated through the intake holes 8 of the housing 4 and blows the relatively cold air as wind from the discharge hole 12b to the first heat-generating component 15.

The heat sink 13 is provided in the vicinity of the exhaust holes 7 of the housing 4 and faces the exhaust holes 7. An example of the heat sink 13 is a fin unit including a plurality of fins.

As shown in FIG. 2, the circuit board 11 has a portion 11a (i.e., interposed portion) disposed between the fan 12 and the heat sink 13. The first heat-generating component 15 (i.e., a component or an electronic component) is mounted on the portion 11a of the circuit board 11 disposed between the fan 12 and the heat sink 13. An example of the first heat-generating component 15 is a central processing unit (CPU). The first heat-generating component 15 is not limited thereto, but various kinds of components (e.g., electronic components) which require heat dissipation may be appropriately used as the first heat-generating component 15.

In this embodiment, the fan 12 does not overlap the circuit board 11. The discharge hole 12b of the fan 12 faces the circuit board 11 (i.e., the fan 12 faces the first heat-generating component 15) in the lateral direction of the housing 4 (i.e., the lateral direction of the display screen 5a), that is, an air flow direction A.

As shown in FIG. 3, a heat receiving portion 16 (i.e., heat receiving member) is attached to the first heat-generating component 15. An example of the heat receiving portion 16 is a metal plate and is thermally connected to the first heat-generating component 15. In some of the drawings, for convenience of explanation, the heat receiving portion 16 is not shown. A first end portion 14a of the thermally-conductive member 14 is attached to the heat receiving portion 16. A second end portion 14b of the thermally-conductive member 14 is attached to the heat sink 13. In this way, the first heat-generating component 15 is thermally connected to the heat sink 13 through the heat receiving portion 16 and the thermally-conductive member 14. An example of the thermally-conductive member 14 is a heat pipe.

As shown in FIG. 2, a first air guide 21 (i.e., first guide portion) and a second air guide 22 (i.e., second guide portion) are provided in the housing 4. The first air guide 21 is provided between the fan 12 and the heat sink 13 (i.e., between the fan and the exhaust hole 7) and surrounds the first heat-generating component 15. In other words, the first air guide 21 surrounds the portion 11a of the circuit board 11 disposed between the fan 12 and the heat sink 13.

That is, the first air guide 21 includes a first wall 21a which is disposed on a first side (e.g., the left side) of the first heat-generating component 15 and a second wall 21b which is disposed on a second side (e.g., the right side) of the first heat-generating component 15. The first wall 21a extends from the fan 12 toward the heat sink 13 (i.e., toward the exhaust hole 7) through the first side of the first heat-generating component 15. The second wall 21b extends from the fan 12 to the heat sink 13 (exhaust hole 7) through the second side of the first heat-generating component 15. The first heat-generating component 15 is disposed between the first wall 21a and the second wall 21b.

The first air guide 21 (e.g., the first wall 21a and the second wall 21b) is interposed between the circuit board 11 and an inner surface 4i (see FIG. 3) of the housing 4. The first air guide 21 blocks the gap between the circuit board 11 and the inner surface 4i of the housing 4. The first air guide 21 is, for example, an elastic member (i.e., a buffer or a flexible member), such as rubber or sponge. When external force is applied to the housing 4, the first air guide 21 which has elasticity (i.e., flexibility) can reduce the load applied to the circuit board 11. The first air guide 21 is attached to the circuit board 11 or the inner surface 4i of the housing 4 by, for example, double-sided tape.

The first air guide 21, the circuit board 11, and the inner surface 4i of the housing 4 form a duct (i.e., a flow path, an air guide path, or a guide portion) between the fan 12 and the heat sink 13 (i.e., between the fan 12 and the exhaust hole 7). The first air guide 21 guides air from the fan 12 toward the heat sink 13 (i.e., toward the exhaust hole 7) through a region around the first heat-generating component 15. In other words, the first air guide 21 guides air from the fan 12 toward the heat sink 13 (i.e., toward exhaust hole 7) through the portion 11a (e.g., the portion 11a in which the first heat-generating component 15 is mounted) of the circuit board 11 disposed between the fan 12 and the heat sink 13.

As shown in FIG. 2, the first heat-generating component 15 faces the discharge hole 12b of the fan 12. The first heat-generating component 15 has, for example, a rectangular shape and includes first to fourth end portions 15a, 15b, 15c, and 15d corresponding to four sides. The first end portion 15a is closest to the fan 12. The first end portion 15a faces the discharge hole 12b in the direction in which the discharge hole 12b of the fan 12 is formed (i.e., air flow direction A) and receives air from the discharge hole 12b.

The first end portion 15a extends substantially in parallel to the discharge hole 12b of the fan 12. That is, the first end portion 15a extends in a direction crossing (e.g., a direction substantially perpendicular to) the air flow direction A. In the specification, the “air flow direction” indicates the flow direction of air discharged from the discharge hole 12b. That is, the “air flow direction” is from the fan 12 to the first heat-generating component 15 and is represented by an arrow A in FIG. 2. In this embodiment, the “air flow direction” is the lateral direction of the housing 4 (i.e., the lateral direction of the display screen 5a). The second end portion 15b is opposite to the first end portion 15a and extends substantially in parallel to the first end portion 15a.

The third end portion 15c and the fourth end portion 15d extend between the first end portion 15a and the second end portion 15b in a direction crossing (e.g., a direction substantially perpendicular to) the first end portion 15a. The third end portion 15c and the fourth end portion 15d extend in the air flow direction A. The fourth end portion 15d is opposite to the third end portion 15c.

In FIG. 2, a white arrow indicates an example of the flow of air. As shown in FIG. 2, air discharged from the discharge hole 12b of the fan 12 collides with the first end portion 15a of the first heat-generating component 15 and flows to both sides (i.e., the first side and the second side) of the first heat-generating component 15.

In this way, a part of the air flows along the third end portion 15c of the first heat-generating component 15. That is, a part of the air flows between the first heat-generating component 15 and the first wall 21a of the first air guide 21. In addition, a part of the air flows along the fourth end portion 15d of the first heat-generating component 15. That is, a part of the air flows between the first heat-generating component 15 and the second wall 21b of the first air guide 21. The air flowing along the third end portion 15c and the fourth end portion 15d tends to flow from the first heat-generating component 15 straight to the rear side (in the air flow direction A).

Therefore, when viewed from the fan 12, air from the fan 12 is less likely to directly reach the rear side (e.g., the back side, a rear region, or a downstream region) of the first heat-generating component 15. Therefore, a stagnant region 25 in which air stagnates is formed on the rear side of the first heat-generating component 15. In the specification, the “rear side” indicates a portion which is away from the first heat-generating component 15, when viewed from the fan 12, a region which is disposed on the downstream side of the first heat-generating component 15 in the air flow direction A, or a region which is opposite to the fan 12 with the first heat-generating component 15 interposed therebetween.

In the specification, the “stagnant region 25” means a region in which the flow rate of air is lower than the average flow rate of air in the first air guide 21 without the second air guide 22. Specifically, an example of the stagnant region 25 is a region in which the flow rate of air is lower than the flow rate of air along the third end portion 15c or the fourth end portion 15d without the second air guide 22. From another point of view, an example of the stagnant region 25 is a region which is disposed on the rear side of the first heat-generating component 15, when viewed from the fan 12. For example, the stagnant region 25 is disposed between the first heat-generating component 15 and the heat sink 13.

In this embodiment, the second air guide 22 is provided in the first air guide 21. That is, the second air guide 22 is provided in the region surrounded by the first air guide 21. The second air guide 22 guides a part of the air in the first air guide 21 toward the rear side of the first heat-generating component 15, when viewed from the fan 12. That is, the second air guide 22 guides a portion of the air in the first air guide 21 toward the stagnant region 25 formed between the first heat-generating component 15 and the heat sink 13.

Specifically, as shown in FIG. 2, at least a portion of the second air guide 22 is disposed on the rear side of the first heat-generating component 15, when viewed from the fan 12. At least a portion of the second air guide 22 faces the second end portion 15b of the first heat-generating component 15 in the air flow direction A. That is, the first heat-generating component 15 is disposed between at least a portion of the second air guide 22 and the fan 12. At least a portion of the second air guide 22 extends so as to be inclined with respect to the air flow direction A from the fan 12.

Specifically, the second air guide 22 includes a first portion 22a (i.e., a first wall or a first rectifying wall) and a second portion 22b (i.e., a second wall or a second rectifying wall). The first portion 22a and the second portion 22b are separated from each other. The first portion 22a is disposed on the rear side of the third end portion 15c of the first heat-generating component 15, when viewed from the fan 12. The second portion 22b is disposed on the rear side of the fourth end portion 15d of the first heat-generating component 15, when viewed from the fan 12.

The first portion 22a and the second portion 22b according to this embodiment are linear flat walls. That is, the first portion 22a and the second portion 22b are, for example, rectangular parallelepipeds. The first portion 22a and the second portion 22b are provided so as to be inclined with respect to the first heat-generating component 15. That is, each of the first portion 22a and the second portion 22b has an angle with respect to the air flow direction A from the fan 12. Each of the first portion 22a and the second portion 22b is provided at an angle α of, for example, 30° to 40° with respect to the second end portion 15b of the first heat-generating component 15. The tilt angle of each of the first portion 22a and the second portion 22b is not limited thereto.

The first portion 22a and the second portion 22b are inclined in a direction in which the distance therebetween is reduced as the distance of the first portion 22a and the second portion 22b from the fan 12 increases. In this embodiment, a region surrounded by the first portion 22a, the second portion 22b, and the first heat-generating component 15 is an example of the stagnant region 25.

A gap C1 serving as an air flow path is formed between the first portion 22a and the second end portion 15b of the first heat-generating component 15. The first portion 22a guides air flowing along the third end portion 15c of the first heat-generating component 15 toward the rear side (i.e., the stagnant region 25) of the first heat-generating component 15, when viewed from the fan 12. Similarly, a gap C2 serving as an air flow path is formed between the second portion 22b and the second end portion 15b of the first heat-generating component 15. The second portion 22b guides air flowing along the fourth end portion 15d of the first heat-generating component 15 toward the rear side (i.e., stagnant region 25) of the first heat-generating component 15, when viewed from the fan 12.

A gap C3 serving as an air flow path is formed between the first portion 22a and the second portion 22b. Air guided by the first portion 22a and the second portion 22b flows toward the rear side of the second air guide 22 through the gap C3 between the first portion 22a and the second portion 22b.

As shown in FIG. 3, the second air guide 22 (e.g., the first portion 22a and the second portion 22b) is interposed between the circuit board 11 and the inner surface 4i of the housing 4. The second air guide 22 blocks the gap between the circuit board 11 and the inner surface 4i of the housing 4. The second air guide 22 is, for example, an elastic member (i.e., a buffer or a flexible member), such as rubber or sponge. When external force is applied to the housing 4, the second air guide 22 which has elasticity (i.e., flexibility) can reduce the load applied to the circuit board 11. The second air guide 22 is attached to the circuit board 11 or the inner surface 4i of the housing 4 by, for example, a double-sided tape 27.

Next, some modifications of the second air guide 22 will be described with reference to FIGS. 4 to 6. As shown in FIG. 4, a second air guide 22 according to a first modification includes a sponge portion 28 and a resin film 29 which is attached to the side (i.e., surface) of the sponge portion 28. As shown in FIG. 5, a second air guide 22 according to a second modification includes a sponge portion 28 and a resin film 29 which is attached to the inside of the sponge portion 28. The sponge portion 28 is an example of an “elastic member”, a “buffer”, or a “flexible member”.

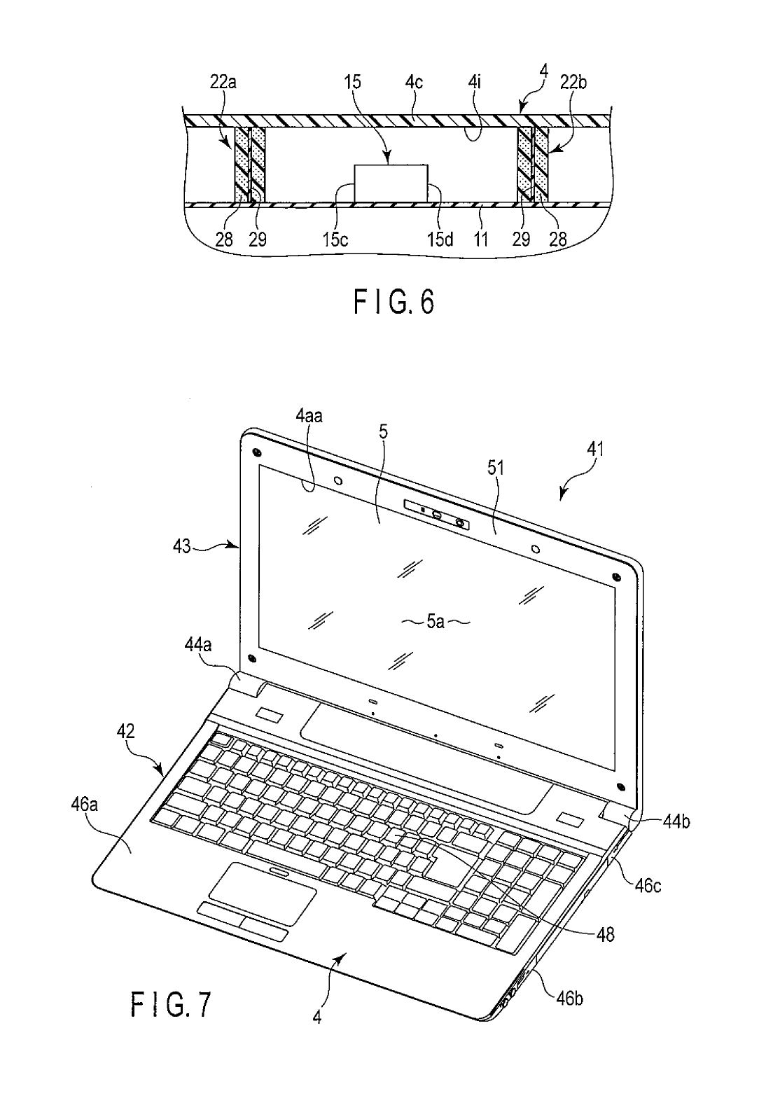

In the first and second modifications, the resin film 29 is, for example, a film member and is thinner than the sponge portion 28. The resin film 29 has a higher airtightness than the sponge portion 28. For example, as shown in FIG. 6, the second air guide 22 according to each of the first and second modifications is interposed between the circuit board 11 and the inner surface 4i of the housing 4, with the resin film 29 extending in a direction crossing (e.g., a direction substantially perpendicular to) the circuit board 11. The resin film 29 is provided between, for example, the circuit board 11 and the inner surface 4i of the housing 4. The resin film 29 makes it possible to increase the airtightness of the second air guide 22 and reduce air permeability. In addition, the first air guide 21 may include the sponge portion 28 and the resin film 29.

As shown in FIG. 2, the circuit board 11 includes a second heat-generating component 31 (i.e., a component or an electronic component) and a third heat-generating component 32 (i.e., a component or an electronic component). At least a portion of each of the second heat-generating component 31 and the third heat-generating component 32 is disposed on the rear side of the first heat-generating component 15, when viewed from the fan 12. The second heat-generating component 31 is provided in the region (i.e., the stagnant region 25) surrounded by the first heat-generating component 15 and the first and second portions 22a and 22b of the second air guide 22. A part of the air guided by the second air guide 22 flows around the second heat-generating component 31.

The third heat-generating component 32 is provided on the rear side of the gap C3 which is between the first portion 22a and the second portion 22b, when viewed from the fan 12. That is, the third heat-generating component 32 is disposed between the heat sink 13 and the gap C3. A part of the air passing through the gap C3 flows around the third heat-generating component 32.

Next, the operation of an air guide structure according to this embodiment will be described.

The fan 12 blows air toward the circuit board 11 (i.e., toward first heat-generating component 15). The relatively cold air (i.e., cooling air) discharged from the discharge hole 12b is guided to the first air guide 21 and flows around the first heat-generating component 15. In this way, the heat dissipation of the first heat-generating component 15 is accelerated. The air passing through the first heat-generating component 15 is guided to the first air guide 21, passes through the heat sink 13, and is exhausted from the exhaust holes 7 to the outside of the housing 4. That is, the cooling air blown from the fan 12 directly reaches to the first heat-generating component 15 (and the heat receiving portion 16) in the region surrounded by the first air guide 21. In this way, heat dissipation is accelerated.

A part of the air flowing in the first air guide 21 reaches the first end portion 15a of the first heat-generating component 15 and flows to both sides of the first heat-generating component 15. Air flowing along the third end portion 15c of the first heat-generating component 15 collides with the first portion 22a of the second air guide 22 and the flow direction of the air is changed. Then, the air is guided by the first portion 22a and flows to the rear region (i.e., stagnant region 25) of the first heat-generating component 15, when viewed from the fan 12.

Similarly, air flowing along the fourth end portion 15d of the first heat-generating component 15 collides with the second portion 22b of the second air guide 22 and the flow direction of the air is changed. Then, the air is guided by the second portion 22b and flows to the rear region (i.e., stagnant region 25) of the first heat-generating component 15, when viewed from the fan 12.

The air guided by the first portion 22a and the second portion 22b flows toward the stagnant region 25 and the flow of air in the stagnant region 25 is improved. In this way, heated air which is likely to stagnate in the stagnant region 25 flows out of the stagnant region 25 and the heat dissipation of the stagnant region 25 is accelerated. Therefore, the heat dissipation of the second end portion 15b of the first heat-generating component 15 is accelerated. In this way, the heat dissipation of the television 1 is accelerated. In addition, the heat dissipation of the second heat-generating component 31 disposed in the stagnant region 25 and the third heat-generating component 32 disposed on the rear side of the first heat-generating component 15 when viewed from the fan 12 is accelerated. In this way, the heat dissipation of the television 1 is further accelerated.

According to this structure, it is possible to improve the heat dissipation performance of the television 1.

That is, the television 1 according to this embodiment includes the first air guide 21 that guides air blown from the fan 12 toward the exhaust holes 7 of the housing 4 through the first heat-generating component 15 and the second air guide 22 that is provided in the first air guide 21. That is, the second air guide 22 is provided in a region to which air is desired to flow locally in the first air guide 21 that makes the main flow of air, which makes it possible to suppress the local stagnation of air in the first air guide 21. In this way, it is possible to suppress heat from being accumulated in a portion of the first air guide 21 and thus improve the heat dissipation performance of the television 1.

The first heat-generating component 15 is provided between the fan 12 and the exhaust holes 7. When the fan 12 blows air to the first heat-generating component 15, the air is less likely to directly reach the rear side of the first heat-generating component 15. Therefore, the stagnant region 25 in which air is less likely to flow is formed on the rear side of the first heat-generating component 15. Therefore, high-temperature air which is heated by the first heat-generating component 15 also stagnates in the stagnant region 25, and the heat dissipation performance of the rear side of the first heat-generating component 15 is likely to be reduced.

In this embodiment, the television 1 includes the first air guide 21 that guides air from the fan 12 toward the heat sink 13 through the portion 11a of the circuit board 11 in which the first heat-generating component 15 is mounted and the second air guide 22 that is provided in the first air guide 21 and guides a part of the air in the first air guide 21 toward the rear side of the first heat-generating component 15, when viewed from the fan 12.

According to this structure, it is possible to effectively blow air to the stagnant region 25 formed between the first heat-generating component 15 and the heat sink 13. In this way, it is possible to improve the stagnant region 25 (i.e., improve heat stagnation) formed on the rear side of the first heat-generating component 15 and thus improve the efficiency of heat dissipation. Specifically, it is possible to accelerate the heat dissipation of the second end portion 15b of the first heat-generating component 15 adjacent to the stagnant region 25. In addition, it is possible to accelerate the heat dissipation of the second and third heat-generating components 31 and 32 disposed on the rear side of the first heat-generating component 15, when viewed from the fan 12.

The inventors verified that, when air was blown to the stagnant region 25 provided on the rear side of the first heat-generating component 15, it was possible to improve the efficiency of heat dissipation by about 20%. Since the efficiency of heat dissipation is improved, the amount of necessary cooling air is reduced and it is possible to reduce the power required to drive the fan 12 and reduce the noise of the fan 12.

In this embodiment, at least a portion of the second air guide 22 is disposed on the rear side of the first heat-generating component 15, when viewed from the fan 12. At least a portion of the second air guide 22 extends so as to be inclined with respect to the air flow direction from the fan 12. In this way, it is possible to blow air toward the rear side of the first heat-generating component 15 without largely obstructing the flow of air in the first air guide 21.

In this embodiment, at least a portion of the second air guide 22 faces the second end portion 15b of the first heat-generating component 15. According to this structure, it is possible to effectively accelerate the heat dissipation of the second end portion 15b of the first heat-generating component 15.

In this embodiment, the second air guide 22 includes the first portion 22a that guides air flowing along the third end portion 15c of the first heat-generating component 15 toward the stagnant region 25 and the second portion 22b that guides air flowing along the fourth end portion 15d toward the stagnant region 25. According to this structure, it is possible to effectively guide air flowing on both sides of the first heat-generating component 15 to the rear side of the first heat-generating component 15.

In this embodiment, the gap C3 is formed between the first portion 22a and the second portion 22b of the second air guide 22. In this way, air guided to the stagnant region 25 smoothly flows to the exhaust holes 7 without stagnating in the stagnant region 25 and does not obstruct the entire air flow. This contributes to improving the heat dissipation performance of the television 1.

The second air guide 22 is interposed between the circuit board 11 and the inner surface 4i of the housing 4. According to this structure, air is less likely to leak and is effectively guided by the second air guide 22. This contributes to improving the heat dissipation performance of the television 1.

An example of the second air guide 22 includes the sponge portion 28 and the resin film 29 attached to the sponge portion 28. The resin film 29 extends in a direction crossing the circuit board 11. In this way, it is possible to improve the airtightness of the second air guide 22 (i.e., reduce air permeability) while ensuring elasticity (i.e., flexibility) and lightness. Therefore, air is less likely to leak from the second air guide 22 and is effectively guided by the second air guide 22. This contributes to improving the heat dissipation performance of the television 1.

Next, second to eighth embodiments will be described. In the following embodiments, components having the same or similar functions as those in the first embodiment are denoted by the same reference numerals and a description thereof will not be repeated.

### Second Embodiment

Next, an electronic apparatus 41 according to the second embodiment will be described with reference to FIGS. 7 to 10. Structures other than the following structures are the same as those in the first embodiment.

The electronic apparatus 41 is, for example, a notebook portable computer (i.e., notebook PC). As shown in FIG. 7, the electronic apparatus 41 includes a first unit 42, a second unit 43, and hinge portions 44a and 44b. The first unit 42 is, for example, a main unit. The first unit 42 includes a first housing 4.

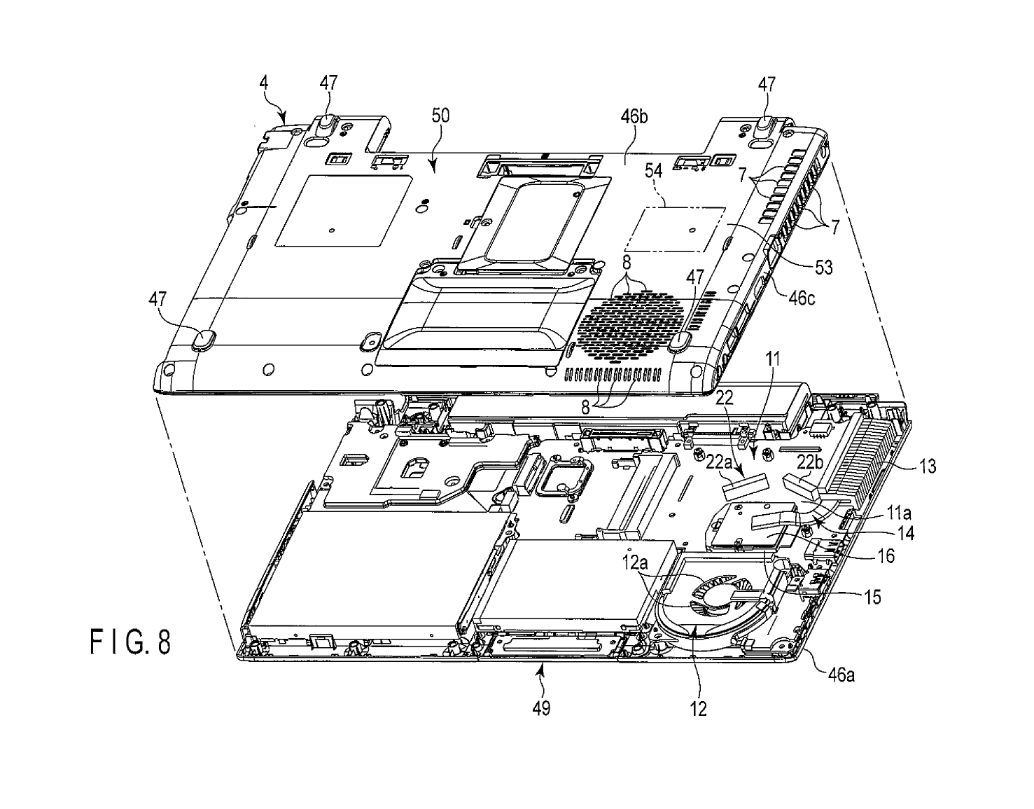

The first housing 4 includes an upper wall 46a, a lower wall 46b, and a circumferential wall 46c and has a flat box shape. The lower wall 46b faces a desk surface when the electronic apparatus 41 is placed on a desk. A plurality of leg portions 47 which come into contact with the desk surface and support the electronic apparatus 41 are provided on the lower wall 46b (see FIG. 8). The upper wall 46a is opposite to the lower wall 46b with a space therebetween and extends substantially in parallel to the lower wall 46b. An input portion 48 (i.e., an input receiving portion) is provided on the upper wall 46a. An example of the input portion 48 is a keyboard. The “input portion” may be a touch panel input device or other input devices.

The circumferential wall 46c rises with respect to the lower wall 46b and connects the circumferential edge portion of the lower wall 46b and the circumferential edge portion of the upper wall 46a. The circumferential wall 46c does not have a defined boundary with the lower wall 46b, but it may be connected to the lower wall 46b in a curved surface shape. At least a portion of the circumferential wall 46c extends in the thickness direction of the housing 4.

As shown in FIG. 8, the housing 4 includes a cover 49 (i.e., upper cover) and a base 50 (i.e., lower cover). The cover 49 includes the upper wall 46a and a portion of the circumferential wall 46c. The base 50 includes the lower wall 46b and a portion of the circumferential wall 46c. The cover 49 and the base 50 are combined with each other to form the housing 4.

The second unit 43 is, for example, a display unit and includes a second housing 51 and a display device 5 provided in the second housing 51. The display device 5 is, for example, a liquid crystal display, but is not limited thereto. The display device 5 includes a display screen 5a on which images are displayed. The second housing 51 includes an opening portion 4aa through which the display screen 5a is exposed to the outside.

The second housing 51 is rotatably (i.e., openably) connected to the rear end of the first housing 4 by the hinge portions 44a and 44b. In this way, the electronic apparatus 41 can be rotated between a first position where the first unit 42 and the second unit 43 overlap each other and a second position where the first unit 42 and the second unit 43 are opened.

Next, the inside of the first housing 4 (hereinafter, simply referred to as the housing 4) will be described in detail.

As shown in FIGS. 8 to 10, the housing 4 includes a circuit board 11, a fan 12, a heat sink 13, and a thermally-conductive member 14. In addition, the housing 4 includes a first air guide 21 and a second air guide 22. The detailed structures of these components are substantially the same as those in the first embodiment. In this way, similarly to the first embodiment, it is possible to improve the heat dissipation performance of the electronic apparatus 41.

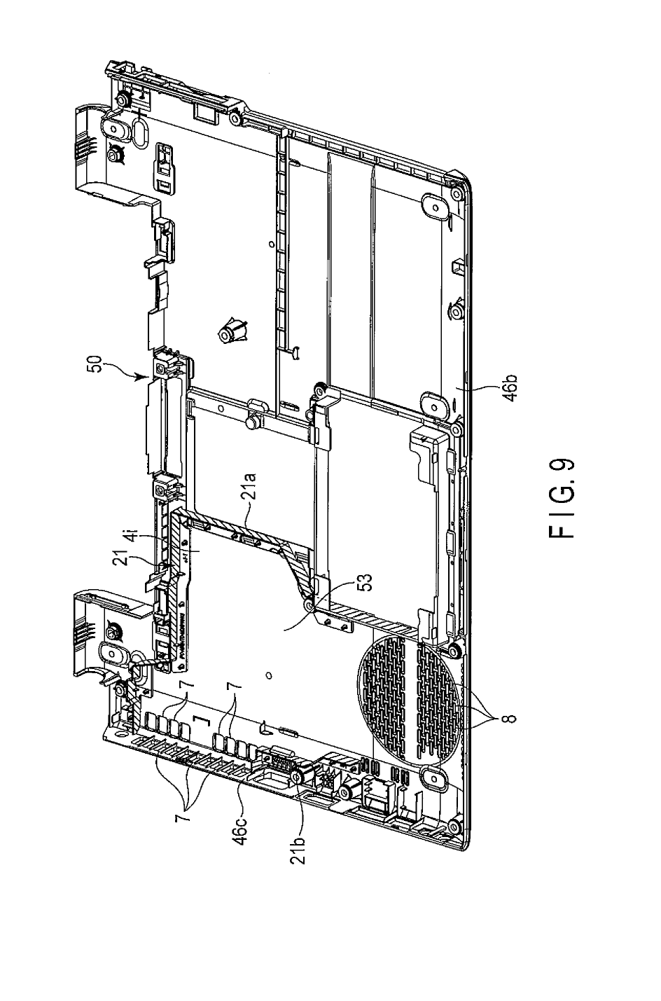

As shown in FIGS. 8 and 9, the housing 4 includes intake holes 8 and exhaust holes 7. The intake holes 8 are provided in the lower wall 46b and a portion of the circumferential wall 46c. The intake holes 8 are provided at a position corresponding to the fan 12 and face an air inlet 12a of the fan 12. The exhaust holes 7 are provided in the lower wall 46b and a portion of the circumferential wall 46c. The exhaust holes 7 are provided at a position corresponding to the heat sink 13 and face the heat sink 13.

As shown in FIGS. 8 and 9, the lower wall 46b includes a closing portion 53 which is provided between the intake hole 8 and the exhaust holes 7 and in which no opening portion is provided. The closing portion 53 extends between the fan 12 and the heat sink 13. That is, the closing portion 53 corresponds to the first air guide 21. In other words, the closing portion 53, the first air guide 21, and the circuit board 11 form a duct for guiding air from the fan 12 toward the heat sink 13. As shown in FIG. 8, the outer surface of the closing portion 53 is configured to be used as, for example, a label attachment region in which a label 54 is attached.

In FIG. 9, for convenience of explanation, the first air guide 21 is hatched. As shown in FIG. 9, the first air guide 21 according to this embodiment includes, for example, ribs (i.e., protrusions) which protrude from the lower wall 46b into the housing 4. That is, the first air guide 21 is formed integrally with the lower wall 46b and is made of metal or plastic. Alternatively, similarly to the first embodiment, the first air guide 21 may be made of an elastic member (i.e., a buffer or a flexible member), such as rubber or sponge.

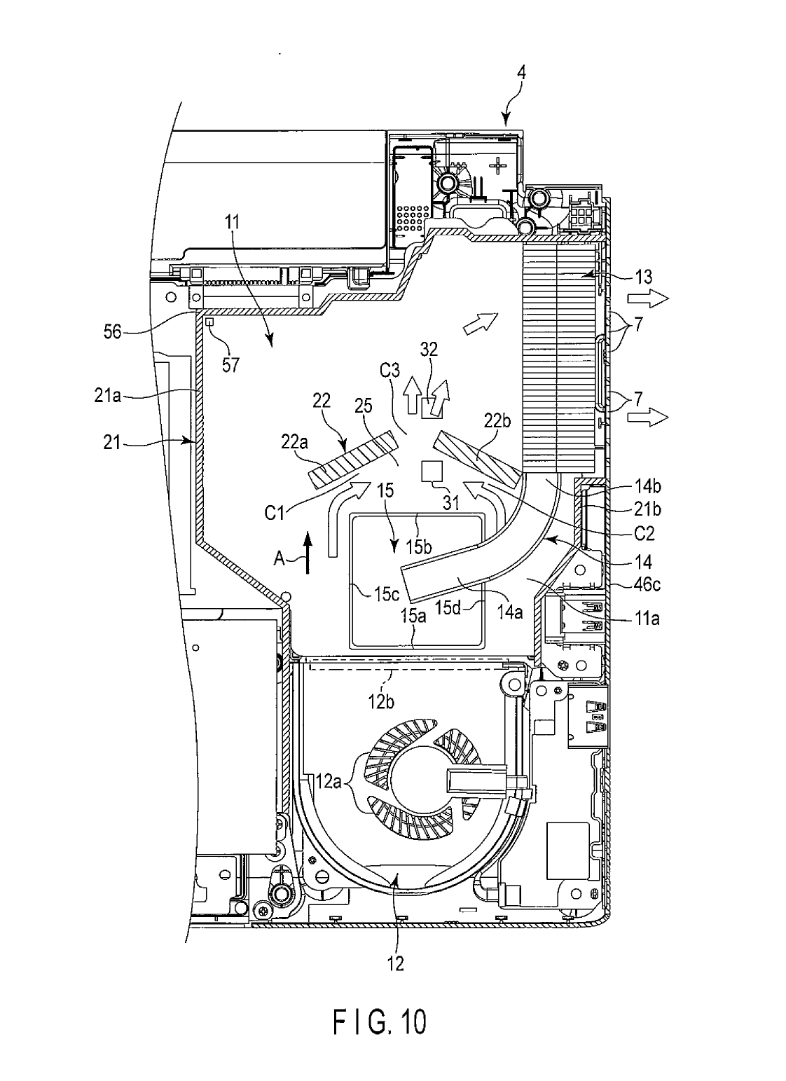

As shown in FIG. 10, a portion of the first air guide 21 is bent. In this way, the first air guide 21 has a corner 56 (i.e., bent portion). The corner 56 is bent at an angle of, for example, 90°, but is not limited thereto. The corner 56 may be bent at an angle more or less than 90°. The vicinity of the corner 56 (i.e., the vicinity of a member having an acute angle) is likely to become the stagnant region 25 in which air stagnates.

At least one of the housing 4 and the circuit board 11 includes a protruding portion 57 (i.e., a wall, a member, a surface, a guide, a wind shielding portion, a partition, or an interposed portion) which is provided in the vicinity of the corner 56 in the first air guide 21. An example of the protruding portion 57 is a component (e.g., electronic component) mounted on the circuit board 11. The protruding portion 57 may be a boss provided on the housing 4, a stud provided on the circuit board 11, or other members.

When the protruding portion 57 is provided in the vicinity of the corner 56, the size of a region which will be the stagnant region 25 is reduced in the vicinity of the corner 56 and air is less likely to stagnate in the vicinity of the corner 56. Therefore, it is possible to improve the heat dissipation performance of the electronic apparatus 41.

### Third Embodiment

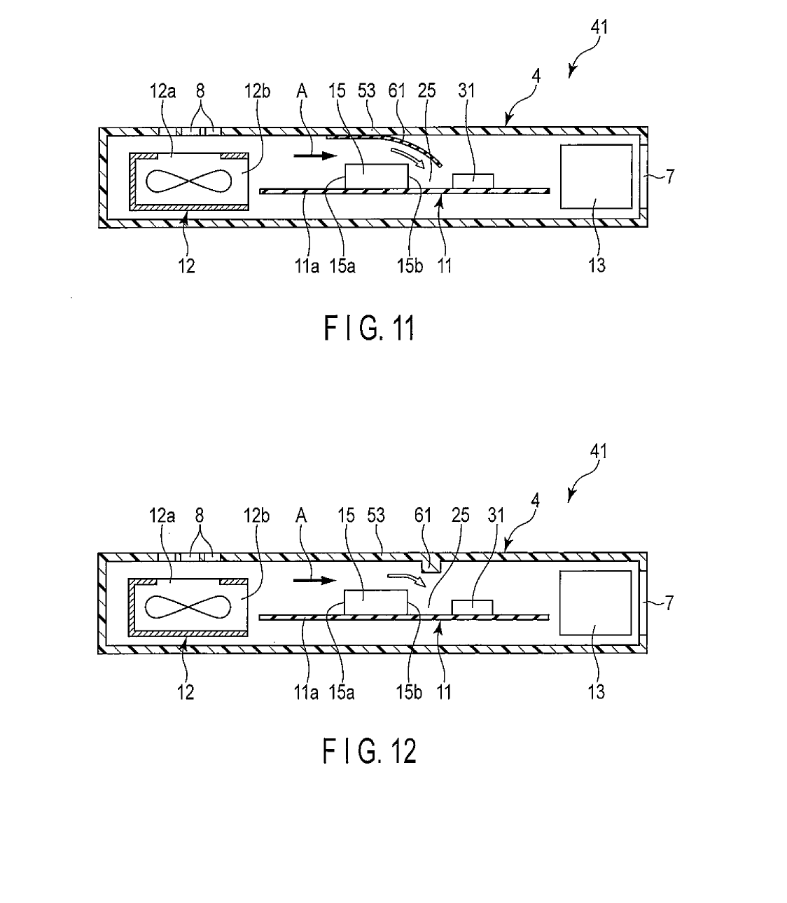

Next, an electronic apparatus 41 according to the third embodiment will be described with reference to FIGS. 11 and 12. Structures other than the following structures are the same as those in the second embodiment.

As shown in FIG. 11, a circuit board 11 has a second component 31 (i.e., a second heat-generating component or a second electronic component) provided on the rear side of a first component 15 (i.e., a first heat-generating component or a first electronic component), when viewed from a fan 12. The first component 15 is, for example, a CPU. The first component 15 is higher than, for example, the second component 31. Air from the fan 12 is less likely to directly reach the rear side of the first component 15, when viewed from the fan 12 and a stagnant region 25 in which air stagnates is likely to be formed on the rear side of the first component 15.

As shown in FIG. 11, in this embodiment, an air guide 61 (i.e., rectifying wall) is provided in a housing 4. The air guide 61 is provided on, for example, an inner surface 4i of the housing 4. The air guide 61 is, for example, an insulator which is attached to the inner surface 4i of the housing 4. At least a portion of the air guide 61 is disposed on the rear side of the first component 15, when viewed from the fan 12.

At least a portion of the air guide 61 extends so as to be inclined with respect to the air flow direction A from the fan 12. In this embodiment, as the distance of the air guide 61 from the fan 12 increases, the air guide 61 is inclined toward the circuit board 11. At least a portion of the air guide 61 faces the second end portion 15b of the first component 15. The air guide 61 guides part of the air, which flows between the first component 15 and the inner surface 4i of the housing 4, toward the circuit board 11. That is, the air guide 61 guides a part of the air blown from the fan 12 toward the stagnant region 25 which is likely to be formed on the rear side of the first component 15. In this way, it is possible to effectively blow air to the rear side of the first component 15. Therefore, it is possible to accelerate the heat dissipation of the second end portion 15b of the first component 15 and the second component 31. This contributes to improving the heat dissipation performance of the electronic apparatus 41.

Similarly to the first embodiment, the air guide 61 according to this embodiment may be provided as a second air guide in the first air guide 21. Similarly to the first embodiment, the air guide 61 according to this embodiment may be provided as a third air guide in the electronic apparatus 41 provided with the first and second air guides 21 and 22. In addition, the air guide 61 according to this embodiment may be combined with the second air guide 22 in the electronic apparatus 41 without the first air guide 21 according to the first embodiment. Only the air guide 61 according to this embodiment may be provided in the electronic apparatus 41 without the first and second air guides 21 and 22.

The air guide 61 may be a flexible printed wiring plate, a flexible cable, or other components, instead of the insulator. As shown in FIG. 12, the air guide 61 may be, for example, a protrusion provided on the housing 4.

### Fourth Embodiment

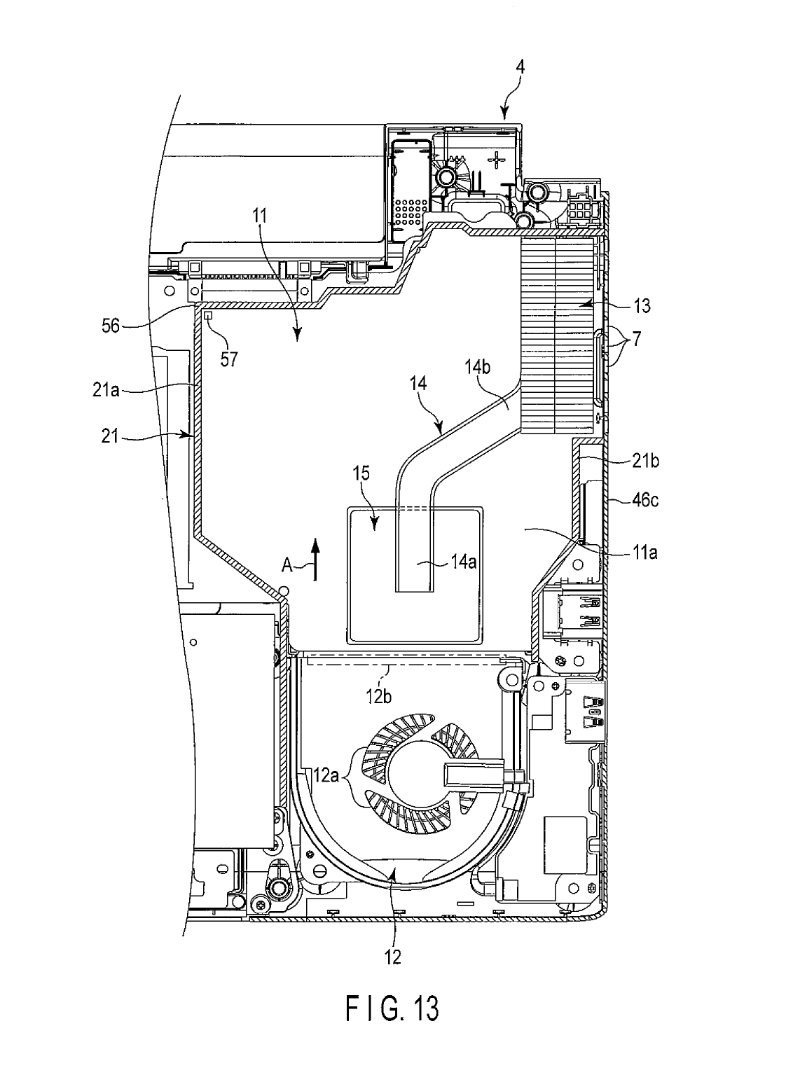

Next, an electronic apparatus 41 according to the fourth embodiment will be described with reference to FIG. 13. Structures other than the following structures are the same as those in the second embodiment.

As shown in FIG. 13, a first end portion 14a of a thermally-conductive member 14 extends in the air flow direction A from a fan 12. Therefore, air blown from the fan 12 is less likely to be obstructed by the first end portion 14b of the thermally-conductive member 14 and can smoothly flow to exhaust holes 7. Therefore, it is possible to improve the heat dissipation performance of the electronic apparatus 41.

### Fifth Embodiment

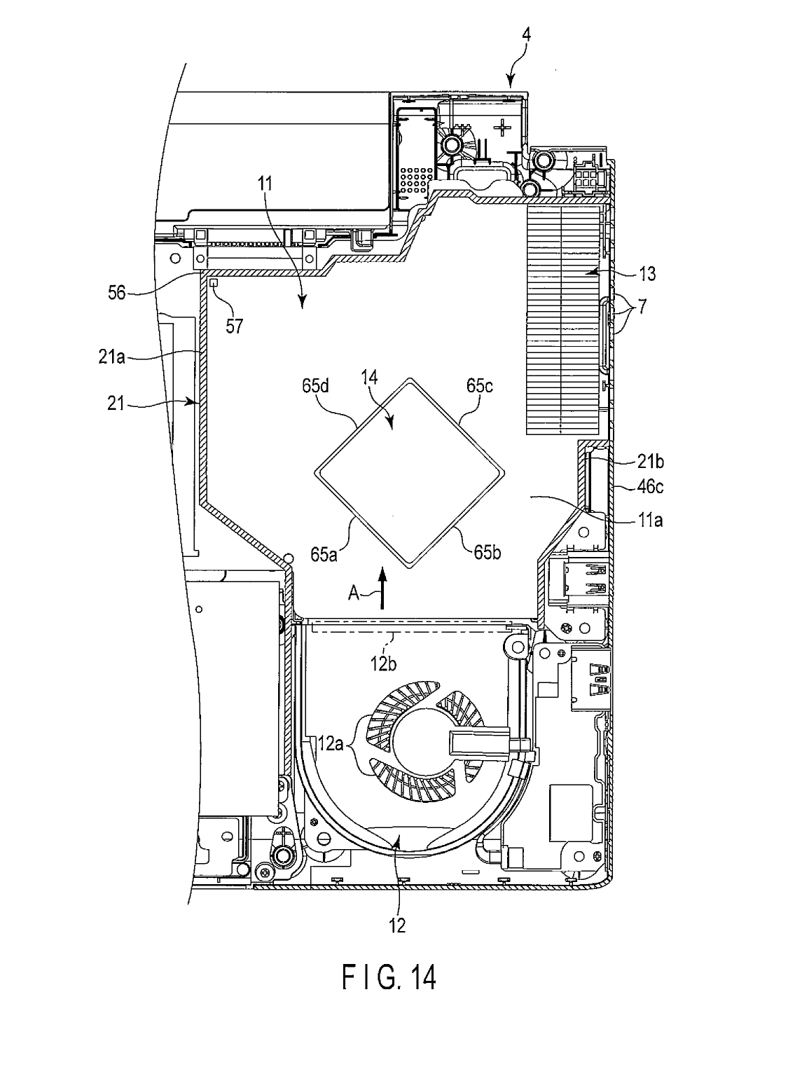

Next, an electronic apparatus 41 according to the fifth embodiment will be described with reference to FIG. 14. Structures other than the following structures are the same as those in the second embodiment.

A circuit board 11 includes a heat-generating component 15. The heat-generating component 15 has, for example, a rectangular shape and includes four sides 65a, 65b, 65c, and 65d. In this embodiment, at least one side 65a of the heat-generating component 15 receiving air from a fan 12 extends so as to be inclined with respect to a discharge hole 12b of the fan 12.

Specifically, the heat-generating component 15 includes the first to fourth side 65a, 65b, 65c, and 65d. The heat-generating component 15 is mounted so as to be inclined at an angle of, for example, 45° with respect to the discharge hole 12b of the fan 12. The first side 65a and the second side 65b are adjacent to each other. The first side 65a and the second side 65b faces the discharge hole 12b of the fan 12 in the air flow direction A. The first side 65a and the second side 65b are inclined such that, as the distance thereof from the fan 12 increases, the distance between the first side 65a and the second side 65b increases.

The third side 65c is opposite to the first side 65a. The fourth side 65d is opposite to the second side 65b. The third side 65c and the fourth side 65d are inclined such that, as the distance thereof from the fan 12 increases, the distance between the third side 65c and the fourth side 65d is reduced.

Air blown from the fan 12 collides with the first side 65a and the second side 65b of the heat-generating component 15 and is divided into air flowing along the first side 65a and air flowing along the second side 65b. A part of the air flowing along the first side 65a turns to the rear side of the heat-generating component 15 so as to flow along the fourth side 65d. A part of the air flowing along the second side 65b turns to the rear side of the heat-generating component 15 so as to flow along the third side 65c.

According to this structure, a small stagnant region 25 is formed on the rear side of the heat-generating component 15 and it is possible to suppress the local accumulation of heat. In this way, it is possible to improve the heat dissipation performance of the electronic apparatus 41. For example, the heat-generating component 15 may or may not be thermally connected to the heat sink 13 through the thermally-conductive member 14.

### Sixth Embodiment

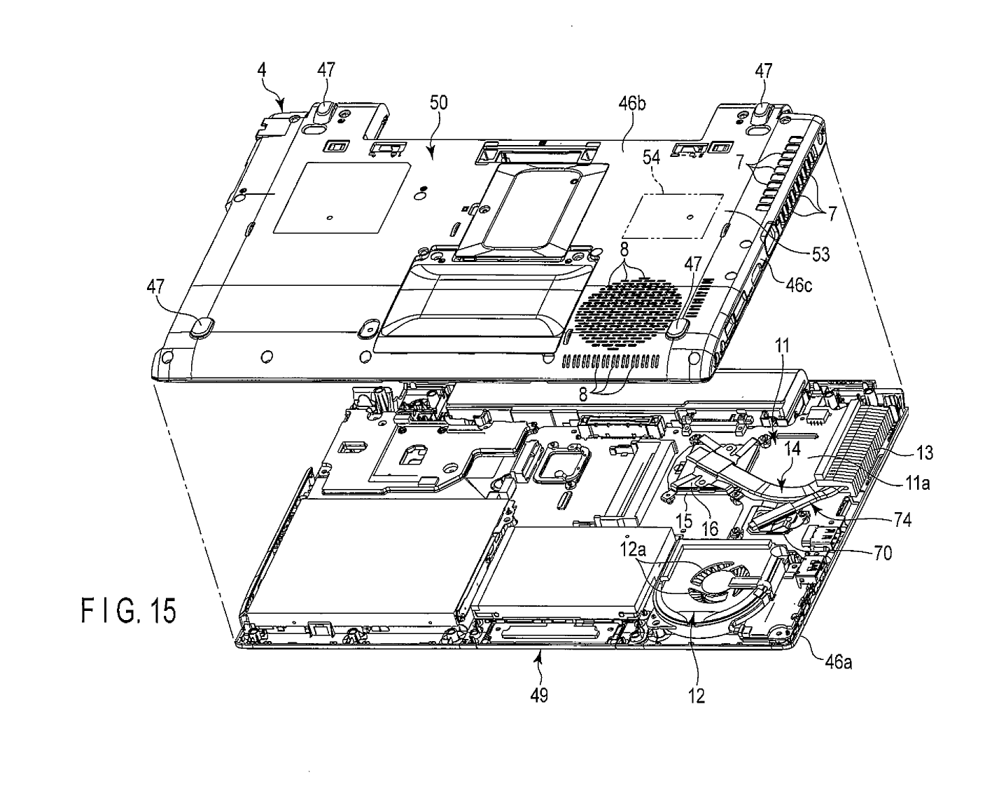

Next, an electronic apparatus 41 according to the sixth embodiment will be described with reference to FIGS. 15 to 18. Structures other than the following structures are the same as those in the second embodiment.

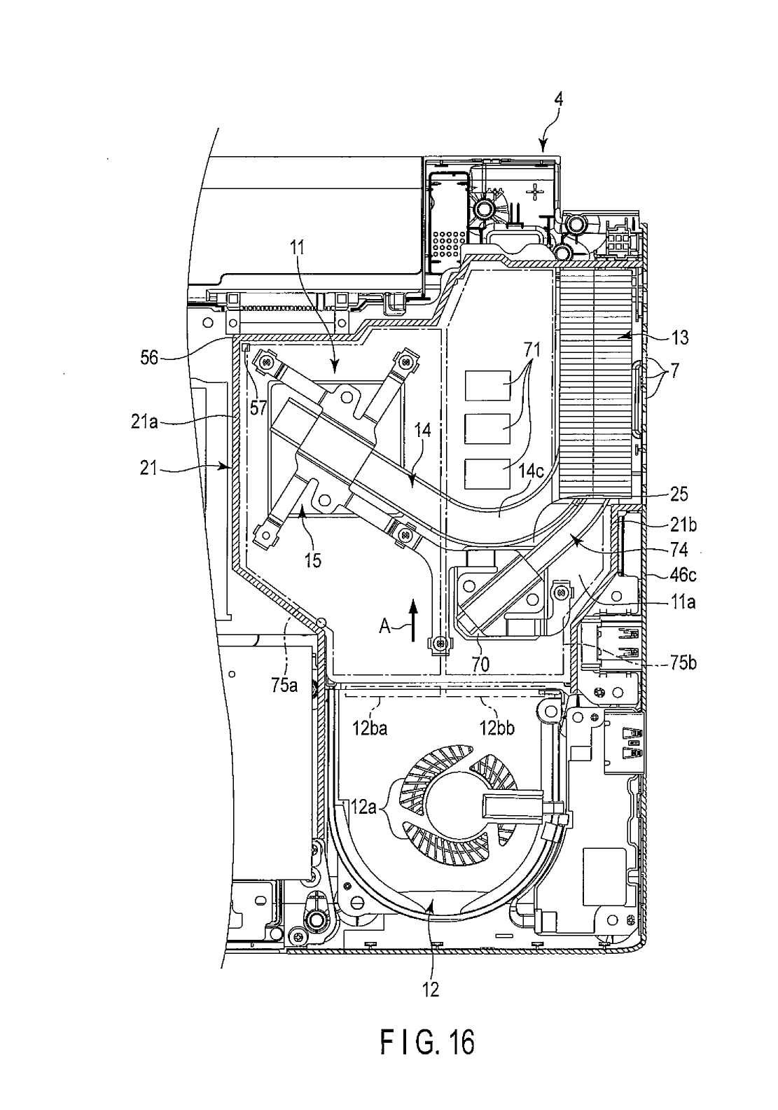

As shown in FIGS. 15 and 16, a circuit board 11 includes a first heat-generating component 15, a second heat-generating component 70, and a plurality of third heat-generating components 71. The first heat-generating component 15, the second heat-generating component 70, and the plurality of third heat-generating components 71 are provided in an air guide 21.

The first heat-generating component 15 is, for example, a CPU. The amount of heat generated from the first heat-generating component 15 is more than the amount of heat generated from the second heat-generating component 70, and is more than the amount of generated from the third heat-generating components 71. For example, the amount of heat generated from the first heat-generating component 15 is substantially equal to the sum of the amount of heat from the second heat-generating component 70 and the amount of heat from the plurality of third heat-generating components 71.

The second heat-generating component 70 is, for example, a graphic chip. The amount of heat generated from the second heat-generating component 70 is more than the amount of heat generated from the third heat-generating component 71. The third heat-generating component 71 is, for example, a power supply component. The first to third heat-generating components 15, 71, and 72 are limited to the above-mentioned examples, but may be various kinds of components which require heat dissipation.

As shown in FIG. 16, the first heat-generating component 15 is thermally connected to a heat sink 13 through the first thermally-conductive member 14. The second heat-generating component 70 is thermally connected to the heat sink 13 through a second thermally-conductive member 74. Each of the first thermally-conductive member 14 and the second thermally-conductive member 74 is, for example, a heat pipe.

As shown in FIG. 16, a portion of the circuit board 11 disposed in the air guide 21 includes a first region 75a and a second region 75b. The first region 75a faces a portion (i.e., first portion 12ba) of a discharge hole 12b of a fan 12 in the air flow direction A and receives air from the first portion 12ba of the discharge hole 12b. The second region 75b faces the remaining portion (i.e., second portion 12bb) of the discharge hole 12b of the fan 12 in the air flow direction A and receives air from the second portion 12bb of the discharge hole 12b.

The first heat-generating component 15 is mounted in the first region 75a. The second heat-generating component 70 and the third heat-generating component 71 are not disposed between the first heat-generating component 15 and the discharge hole 12b of the fan 12. Therefore, the first heat-generating component 15 can directly receive air which is not heated from the fan 12. According to this structure, it is possible to improve the heat dissipation performance of the electronic apparatus 41.

The second heat-generating component 70 and the third heat-generating component 71 are mounted in the second region 75b. The first heat-generating component 15 and the third heat-generating component 71 are not disposed between the second heat-generating component 70 and the discharge hole 12b of the fan 12. Therefore, the second heat-generating component 70 can directly receive air which is not heated from the fan 12.

That is, in the structure according to this embodiment, the first and second heat-generating components 15 and 70 which generate a relatively large amount of heat are arranged in parallel to each other with respect to the discharge hole 12b of the fan 12. That is, the first and second heat-generating components 15 and 70 are separately arranged in the longitudinal direction of the discharge hole 12b of the fan 12 such that the first and second heat-generating components 15 and 70 do not overlap each other in the air flow direction A. According to this structure, it is possible to improve the heat dissipation performance of the electronic apparatus 41.

In this embodiment, for example, substantially the same mount of heat is generated from the first region 75a having the first heat-generating component 15 provided therein and the second region 75b having the second heat-generating component 70 and the third heat-generating component 71 provided therein. That is, the heat-generating components are distributed to the first region 75a and the second region 75b such that the thermal balance of the first region 75a is substantially the same as that of the second region 75b. According to this structure, it is possible to suppress the generation of local heat and thus improve the heat dissipation performance of the electronic apparatus 41.

As shown in FIG. 16, the first thermally-conductive member 14 includes a portion 14c (hereinafter, referred to as a neighboring portion 14c) which is disposed on the rear side of the second heat-generating component 70, when viewed from the fan 12. The neighboring portion 14c of the first thermally-conductive member 14 functions as a second air guide 22 that guides a part of the air in the first air guide 21 toward a stagnant region 25 formed on the rear side of the second heat-generating component 70. According to this structure, it is possible to suppress air from stagnating on the rear side of the second heat-generating component 70 and improve the heat dissipation performance of the electronic apparatus 41.

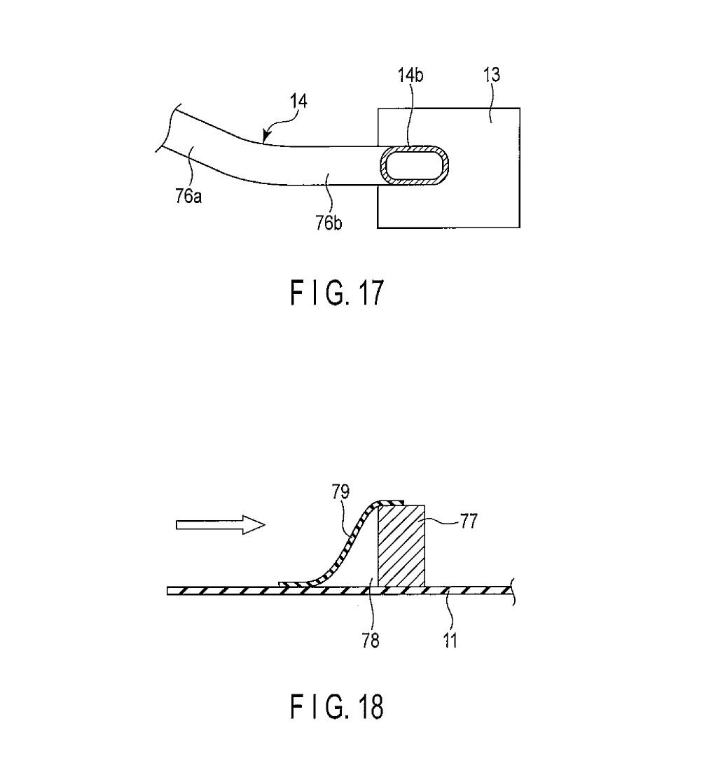

As shown in FIG. 17, the first thermally-conductive member 14 according to this embodiment does not obliquely extend in a portion adjacent to the heat sink 13. The first thermally-conductive member 14 includes a first portion 76a that extends so as to be inclined and a second portion 76b that is provided between the first portion 76a and the heat sink 13 and extends substantially in the horizontal direction. In other words, the second portion 76b adjacent to the heat sink 13 extends substantially in parallel to a lower wall 46b (or an upper wall 46a) of the housing 4.

According to this structure, the first portion 76a (i.e., inclined portion) of the first thermally-conductive member 14 hardly covers the heat sink 13. Therefore, air blown from the fan 12 is less likely to be obstructed by the first thermally-conductive member 14 and can smoothly flow toward the heat sink 13. As a result, it is possible to improve the heat dissipation performance of the electronic apparatus 41.

As shown in FIG. 18, the circuit board 11 has a component 77 (e.g., electronic component). The component 77 is provided in, for example, the air guide 21 and receives air from the fan 12. The component 77 rises (e.g., stands upright) with respect to the circuit board 11. A corner 78 defined by the component 77 and the circuit board 11 is provided at the intersection between the component 77 and the circuit board 11. The stagnant region 25, in which air stagnates, is likely to be formed in the vicinity of the corner 78.

In this embodiment, an air guide 79 is provided between the circuit board 11 and a surface of the component 77. An example of the air guide 79 is an insulator. The air guide 79 covers the corner 78. According to this structure, air is less likely to stagnate at the corner 78 and it is possible to improve the heat dissipation performance of the electronic apparatus 41.

### Seventh Embodiment

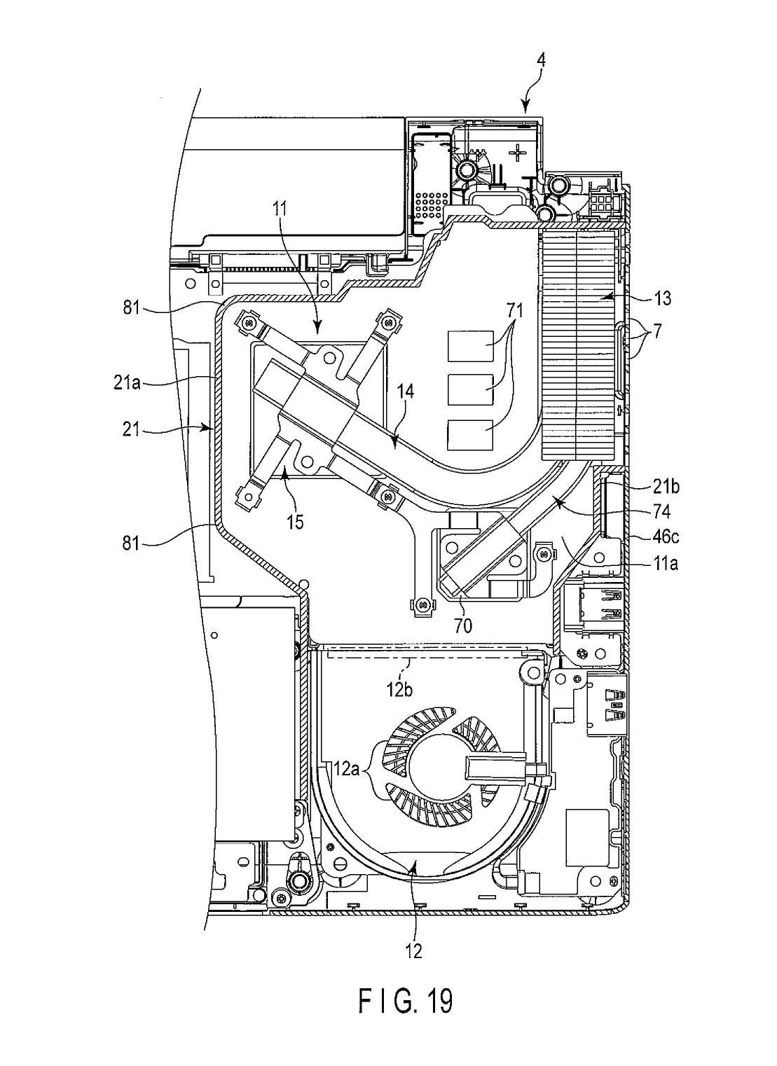

Next, an electronic apparatus 41 according to the seventh embodiment will be described with reference to FIG. 19. Structures other than the following structures are the same as those in the second embodiment.

In this embodiment, an air guide 21 includes a curved surface portion 81, instead of the corner 56 according to the second embodiment. According to the curved surface portion 81, air is less likely to stagnate, as compared to the corner 56. Therefore, it is possible to improve the heat dissipation performance of the electronic apparatus 41.

### Eighth Embodiment

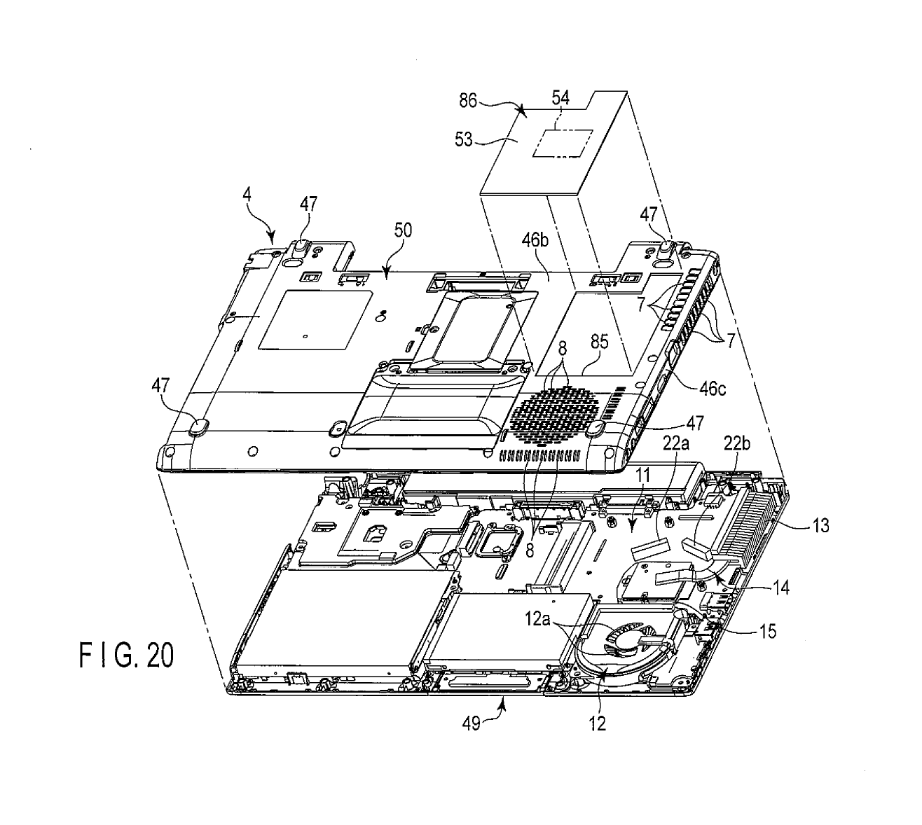

Next, an electronic apparatus 41 according to the eighth embodiment will be described with reference to FIG. 20. Structures other than the following structures are the same as those in the second embodiment.

In this embodiment, a closing portion 53 of a lower wall 46b of a housing 4 includes an opening portion 85 and a cover 86 that is removably attached to the opening portion 85. When the cover 86 is removed, it is possible to clean the inside of a first air guide 21.

The embodiments are not limited to the above-described embodiments, but the components of the above-described embodiments may be changed without departing from the scope and spirit of the invention. In addition, a plurality of components according to the above-described embodiments may be appropriately combined with each other to form various structures. For example, some of the components according to the above-described embodiments may be removed. Components according to different embodiments may be appropriately combined with each other.

Electronic apparatuses to which the first to eighth embodiments can be applied are not limited to the above. The first to eighth embodiments can be widely applied to various kinds of electronic apparatuses including notebook PCs, televisions, mobile phones, smart phones, e-book terminals, and game machines.

Each of the first air guide 21, the second air guide 22, the air guide 61, and the air guide 79 is an example of a “wall”, a “member”, a “surface”, a “guide”, a “wind shielding portion”, a “partition”, or an “interposed portion” provided in the housing 4.

For example, the structure, size, and installation position of the air guides 21, 22, 61, and 79 are not limited to the above examples. In order to improve the heat dissipation performance of the stagnant region 25, the first air guide 21 is not an indispensable component, and only the second air guide 22 may be provided. That is, the second air guide 22 may be provided in a television or an electronic apparatus in which the first air guide 21 is not provided. Only one of the first portion 22a and second portion 22b of the second air guide 22 may be provided. The first air guide 21 and the second air guide 22 are not limited to sponge members or ribs. At least a portion of the first air guide 21 and the second air guide 22 may be, for example, a component (e.g., a connector) mounted on the circuit board 11.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A television comprising:
a housing comprising an exhaust;
a fan in the housing;
a heat sink in the housing, the heat sink facing the exhaust;
a circuit board, wherein a portion of the circuit board is between the fan and the heat sink;
a heat-generating component on the portion of the circuit board and thermally connected to the heat sink;
a first air guide configured to guide air from the fan toward the heat sink through the portion of the circuit board; and
a second air guide in the first air guide, the second air guide configured to guide some of the air in the first air guide toward a region between the heat-generating component and heat sink.

2. The television of claim 1,
wherein the heat-generating component is between the fan and at least a portion of the second air guide, the portion of the second air guide inclined with respect to a direction of airflow from the fan.

3. The television of claim 1,
wherein the heat-generating component comprises a first end portion configured to receive the air from the fan and a second end portion opposite the first end portion, and
at least a portion of the second air guide faces the second end portion of the heat-generating component.

4. The television of claim 3,
wherein the heat-generating component further comprises a third end portion that extends between the first end portion and the second end portion and a fourth end portion that is opposite the third end portion and extends between the first end portion and the second end portion, and
the second air guide comprises a first portion configured to guide some of the air flowing along the third end portion toward the region between the heat-generating component and heat sink, and a second portion configured to guide some air flowing along the fourth end portion toward the region between the heat-generating component and heat sink.

5. The television of claim 4,
wherein the second air guide comprises a gap between the first portion and the second portion.

6. The television of claim 1,
wherein the second air guide is between the circuit board and an inner surface of the housing.

7. The television of claim 1,
wherein the second air guide comprises a sponge and a resin film attached to the sponge, and
the resin film extends in a direction crossing the circuit board.

8. The television of claim 1,
wherein the second air guide is on an inner surface of the housing and configured to guide some of the air flowing between the heat-generating component and the inner surface of the housing toward the circuit board.

9. The television of claim 1,
wherein the first air guide comprises a corner, and
the housing, the circuit board, or a combination thereof comprises a protrusion in a vicinity of the corner in the first air guide.

10. An electronic apparatus comprising:
a housing comprising an exhaust;
a circuit board in the housing, the circuit board comprising a heat-generating component;
a fan in the housing;
a first air guide configured to guide air from the fan toward the exhaust through the heat-generating component; and
a second air guide in the first air guide.

11. An electronic apparatus comprising:
a housing;
a circuit board in the housing;
a fan in the housing, the fan comprising a discharge; and
a heat-generating component on the circuit board, the heat-generating component comprising a side configured to receive air from the fan, the side inclined with respect to the discharge.
